(19) United States
(12) Patent Application Publication
(10) Pub. No.: US 2025/0227370 A1
(43) Pub. Date: Jul. 10, 2025

(54) SHAKE CORRECTION DEVICE

(71) Applicant: FUJIFILM Corporation, Tokyo (JP)

(72) Inventors: Takuro ABE, Saitama (JP); Shuhei MATSUSHITA, Saitama (JP); Kouhei AWAZU, Saitama (JP)

(73) Assignee: FUJIFILM Corporation, Tokyo (JP)

(21) Appl. No.: 19/091,736

(22) Filed: Mar. 26, 2025

Related U.S. Application Data
(63) Continuation of application No. PCT/JP2023/032836, filed on Sep. 8, 2023.

(30) Foreign Application Priority Data
Sep. 29, 2022 (JP) 2022-156998

(51) Int. Cl. H04N 23/68; H04N 23/54

(52) U.S. Cl. CPC H04N 23/685; H04N 23/54

(57) ABSTRACT

Provided is a shake correction device that can reduce weight and cost. A shake correction device drives an imaging element (210) by using a drive mechanism to perform a shake correction. The shake correction device includes: a fixing section (102) that includes a magnet (113b, 115b, 117b), a first yoke (103), and a second yoke (105) that constitute the drive mechanism (voice coil motor); and a movable section (101) that includes a holding member (104) that holds a coil (113a, 115a, 117a) constituting the drive mechanism and the imaging element (210), and that supports the holding member (104) in a movable manner, in which the imaging element (210) and the holding member (104) adhere to each other with a first adhesive (150a, 150b).

### CROSS-REFERENCE TO RELATED APPLICATIONS

The present application is a Continuation of PCT International Application No. PCT/JP2023/032836 filed on Sep. 8, 2023 claiming priority under 35 U.S.C § 119(a) to Japanese Patent Application No. 2022-156998 filed on Sep. 29, 2022. Each of the above applications is hereby expressly incorporated by reference, in its entirety, into the present application.

### BACKGROUND OF THE INVENTION

### 1. Field of the Invention

The present invention relates to a shake correction device, and more particularly to a shake correction device that derives an imaging element to correct an image shake.

### 2. Description of the Related Art

Examples of a shake correction device of this type in the related art are described in JP2008-64863A and JP2011-4075A.

A camera shake correction mechanism described in JP2008-64863A uses a piezoelectric actuator as a drive mechanism of an imaging element, to perform a camera shake correction by moving the imaging element in directions orthogonal to each other on a plane orthogonal to an optical axis. In particular, the camera shake correction mechanism described in JP2008-64863A includes a heat radiation mechanism that radiates heat of the imaging element from a rear surface of the imaging element to a gas phase.

It should be noted that JP2008-64863A describes that the imaging element (a substrate provided with the imaging element) is held by an imaging element holder, but does not describe a method of fixing the imaging element to the imaging element holder.

A shake correction device described in JP2011-4075A includes a base section, a movable section that holds an imaging element, a support ball that is disposed between the movable section and the base section, that supports the movable section in a movable manner with respect to the base section, and that consists of a material having magnetism, a drive unit that includes a coil and a magnet and that moves the movable section relative to the base section by using an electromagnetic force, and a shield section that consists of a material having magnetism, that surrounds an outer side of a rolling range of the support ball, and that covers half or more of the support ball in a direction orthogonal to an optical axis in a case of being seen in a direction orthogonal to the optical axis. The shake correction device described in JP2011-4075A surrounds the outer side of the rolling range of the support ball consisting of the material having magnetism by the shield section consisting of the material having magnetism, and thereby reducing or eliminating an influence of the magnetic force acting on the support ball and making it possible to easily and accurately control a position of the movable section even in a case in which the support ball consisting of the material having magnetism is used.

It should be noted that, although JP2011-4075A describes that the movable section includes an imaging element holding section that holds the imaging element and a substantially L-shaped holder that holds the coil, the imaging element holding section and the holder being fixed by a screw and an adhesive, but does not describe a method of fixing the imaging element and the coil.

### SUMMARY OF THE INVENTION

One embodiment according to the technology of the present disclosure provides a shake correction device that can reduce weight and cost.

A first aspect of the present invention relates to a shake correction device that drives an imaging element by using a drive mechanism to perform a shake correction, the shake correction device comprising: a fixing section that includes a magnet and a yoke that constitute the drive mechanism; and a movable section that includes a holding member that holds a coil constituting the drive mechanism and the imaging element, and that supports the holding member in a movable manner, in which the imaging element and the holding member adhere to each other with a first adhesive.

A second aspect of the present invention relates to the shake correction device according to the first aspect, in which the drive mechanism is a voice coil motor.

A third aspect of the present invention relates to the shake correction device according to the first aspect, in which the movable section supports the holding member in a movable manner in a plane parallel to an imaging surface of the imaging element with respect to the fixing section.

A fourth aspect of the present invention relates to the shake correction device according to the first aspect, in which it is preferable that the holding member is a resin member molded of a high thermal conductivity resin.

A fifth aspect of the present invention relates to the shake correction device according to the fourth aspect, in which a thermal conductivity of the high thermal conductivity resin is 2 (W/m/K) or more.

A sixth aspect of the present invention relates to the shake correction device according to the fourth aspect, in which a thermal conductivity of the high thermal conductivity resin is preferably 3 (W/m/K) or more.

A seventh aspect of the present invention relates to the shake correction device according to the fourth aspect, in which it is preferable that the high thermal conductivity resin is a resin containing fibrous fillers.

An eighth aspect of the present invention relates to the shake correction device according to the seventh aspect, in which it is preferable that the holding member is molded in a frame shape, and a direction of the fibrous fillers in the holding member is aligned in a direction along the frame shape.

A ninth aspect of the present invention relates to the shake correction device according to the first aspect, in which it is preferable that the holding member is a resin member molded of a conductive resin.

A tenth aspect of the present invention relates to the shake correction device according to the fourth aspect, in which it is preferable that the holding member is a resin member molded of a conductive resin.

An eleventh aspect of the present invention relates to the shake correction device according to any one of the first to tenth aspects, in which it is preferable that the holding member has a shape that increases an adhesive area of the first adhesive.

A twelfth aspect of the present invention relates to the shake correction device according to the eleventh aspect, in which the first adhesive is applied in the shape.

A thirteenth aspect of the present invention relates to the shake correction device according to the eleventh aspect, in which it is preferable that the shape is a recess-protrusion shape.

A fourteenth aspect of the present invention relates to the shake correction device according to the thirteenth aspect, in which it is preferable that the holding member has a plurality of the recess-protrusion shapes.

A fifteenth aspect of the present invention relates to the shake correction device according to the fourteenth aspect, in which it is preferable that the holding member is molded in a frame shape and has the plurality of recess-protrusion shapes on at least two sides of the frame shape.

A sixteenth aspect of the present invention relates to the shake correction device according to the first aspect, in which it is preferable that the holding member includes a restricting member that restricts a movable range of the movable section by abutting on the fixing section, and the first adhesive is applied between the imaging element and the holding member that are spaced apart from the restricting member by a first distance or more.

A seventeenth aspect of the present invention relates to the shake correction device according to the sixteenth aspect, in which it is preferable that the holding member has a shape that increases an adhesive area of the first adhesive, and the shape that increases the adhesive area of the first adhesive is spaced apart from the restricting member by the first distance or more.

An eighteenth aspect of the present invention relates to the shake correction device according to the first aspect, in which it is preferable that the first adhesive is an ultraviolet curable adhesive.

A nineteenth aspect of the present invention relates to the shake correction device according to the sixteenth aspect, in which it is preferable that a second adhesive having a lower hardness than the first adhesive is applied to a portion different from a portion to which the first adhesive is applied.

A twentieth aspect of the present invention relates to the shake correction device according to the nineteenth aspect, in which the holding member has a shape that increases an adhesive area of the first adhesive, and the different portion is a portion excluding the shape that increases the adhesive area of the first adhesive.

A twenty-first aspect of the present invention relates to the shake correction device according to any one of the fourth to tenth aspects, in which it is preferable that the holding member is formed with a screw hole that is a non-through hole deeper than a length of a male screw.

A twenty-second aspect of the present invention relates to the shake correction device according to any one of the first to tenth aspects, in which it is preferable that the holding member includes a first opening portion in which the imaging element is disposed and includes, on an outer side of the first opening portion, a second opening portion in which the coil is disposed, and a space between the coil and an inner peripheral surface of the second opening portion is filled with the first adhesive.

A twenty-third aspect of the present invention relates to the shake correction device according to the twenty-second aspect, in which it is preferable that the second opening portion has a first opening shape in which a periphery of the second opening portion is closed or a second opening shape in which a part of the periphery of the second opening portion is open.

### BRIEF DESCRIPTION OF THE DRAWINGS

FIG. 1 is a perspective view of an imaging device to which a shake correction device according to an embodiment of the present invention is applied, as seen obliquely from the front.

FIG. 2 is a block diagram showing an embodiment of an internal configuration of the imaging device shown in FIG. 1.

FIG. 3 is a front perspective view of the shake correction device.

FIG. 4 is a rear perspective view of the shake correction device.

FIG. 5 is a front perspective view of a fixing section of the shake correction device.

FIG. 6 is a rear perspective view of a movable section of the shake correction device.

FIG. 7 is a rear view of a holding member constituting the movable section.

FIG. 8 is a front view of the holding member constituting the movable section.

FIG. 9 is a graph showing an example of a temperature rise of a raw material of the holding member and an imaging element (CMOS) with respect to a usage time.

FIG. 10 is a rear view of the holding member to which the imaging element is adhesively fixed.

FIG. 11 is a rear view of the holding member to which the imaging element is adhesively fixed, and is a view particularly showing a range of the imaging element and a range close to a restricting member.

FIG. 12 is a perspective view showing a part of the holding member shown in FIG. 10.

FIG. 13 is a schematic view showing another embodiment of the movable section.

FIG. 14 is a main part cross-sectional view of the holding member including a cross section of a screw hole formed in the holding member.

FIGS. 15A and 15B are diagrams showing a configuration in which a flexible printed circuit connected to a rear surface side of the imaging element is fastened to the holding member.

### DESCRIPTION OF THE PREFERRED EMBODIMENTS

Hereinafter, a preferable embodiment of a shake correction device according to an embodiment of the present invention will be described with reference to the accompanying drawings.

### Imaging Device

### Appearance of Imaging Device

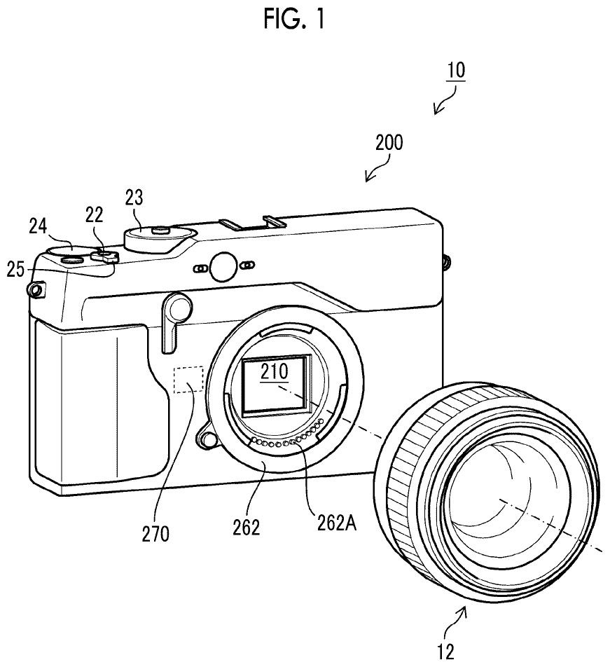

FIG. 1 is a perspective view of an imaging device including a shake correction device according to an embodiment of the present invention, as seen obliquely from the front.

As shown in FIG. 1, an imaging device 10 is a mirrorless digital single-lens camera including an interchangeable lens 12 and a camera body 200 to and from which the interchangeable lens 12 is attachable and detachable.

In FIG. 1, a body mount 262 on which the interchangeable lens 12 is mounted is provided on a front surface of the camera body 200, and a shutter release button 22, a shutter speed dial 23, an exposure correction dial 24, a power lever 25, and the like are mainly provided on an upper surface of the camera body 200. It should be noted that a reference numeral 262A indicates a contact point connected to the interchangeable lens 12.

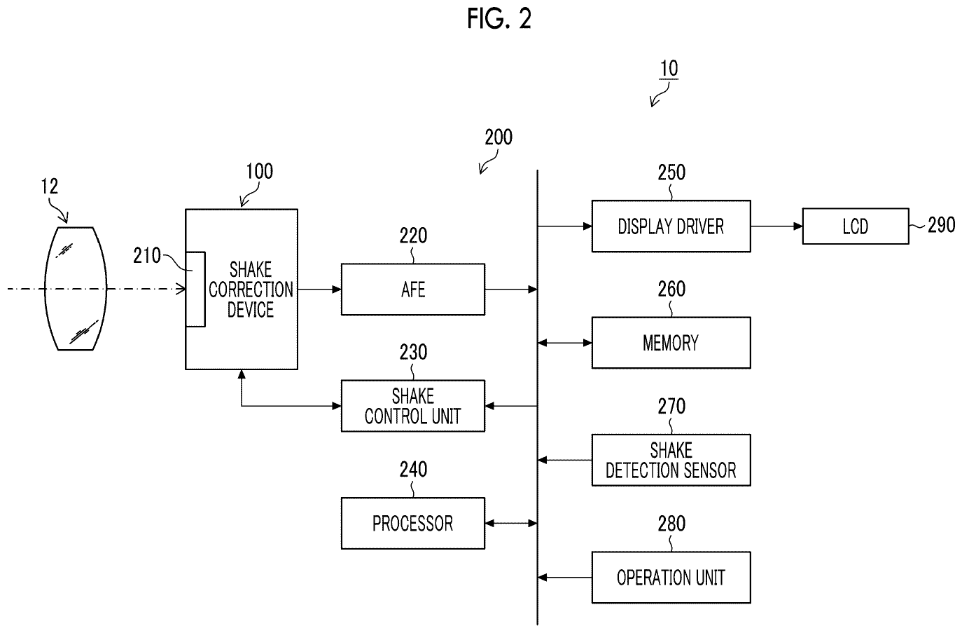

In addition, a liquid crystal display (LCD) 290 (FIG. 2), a MENU/OK key, a cross key, a play button, and the like are provided on a rear surface (not shown) of the camera body 200.

The LCD 290 functions as a display that displays a live view image in an imaging mode, that plays and displays an image captured in a playback mode, and that displays various menu screens.

Further, a shake detection sensor 270 is disposed in the camera body 200.

The shake detection sensor 270 is configured by a gyro sensor (angular velocity sensor) and an acceleration sensor, and, in a case in which a left-right direction of the camera body 200 is defined as an X-axis, an up-down direction of the camera body 200 is defined as a Y-axis, and an optical axis direction is defined as a Z-axis as shown in FIG. 1, the angular velocity sensor detects an angular velocity in an X-axis direction (tilt direction), an angular velocity in a Y-axis direction (pan direction), and an angular velocity in a Z-axis direction (roll direction), and the acceleration sensor detects the acceleration in the X-axis direction and the acceleration in the Y-axis direction.

### Internal Configuration of Imaging Device

FIG. 2 is a block diagram showing an embodiment of an internal configuration of the imaging device shown in FIG. 1.

In FIG. 2, the camera body 200 constituting the imaging device 10 comprises an imaging element 210, a shake correction device 100 according to the embodiment of the present invention, an analog front-end (AFE) 220, a shake control unit 230, a processor 240, a display driver 250, a memory 260, the shake detection sensor 270, an operation unit 280, and the LCD 290.

The imaging element 210 is configured by a complementary metal-oxide semiconductor (CMOS) type color image sensor. It should be noted that the imaging element 210 is not limited to the CMOS type, and may be a charge-coupled device (CCD) type image sensor.

In the imaging element 210, color filters of red (R), green (G), and blue (B) are arranged in a periodic color arrangement (for example, a Bayer arrangement, X-Trans (registered trademark), and the like) on a plurality of pixels composed of photoelectric conversion elements (photodiodes) two-dimensionally arranged in an x direction (horizontal direction) and a y direction (vertical direction), and micro-lenses are disposed on each photodiode.

An optical image of a subject formed on a light-receiving surface of the imaging element 210 by an imaging optical system of the interchangeable lens 12 is converted into an electric signal by the imaging element 210. A charge corresponding to an amount of incident light is accumulated in each pixel of the imaging element 210, and the electric signal corresponding to the amount of charge (signal charge) accumulated in each pixel is read out from the imaging element 210 as an image signal.

The shake correction device 100 drives the imaging element 210 by a drive mechanism to perform a shake correction, and corrects an image shake associated with a shake in five directions of the pan direction, the tilt direction, the roll direction, the up-down direction, and the left-right direction of the camera body 200. It should be noted that a detailed configuration of the shake correction device 100 will be described later.

The shake control unit 230 inputs shake detection signals indicating the angular velocities in directions of respective axes of the X-axis, the Y-axis, and the Z-axis and the acceleration in respective directions of the X-axis and the Y-axis, which are detected by the shake detection sensor 270 during the capturing of the image (still image or video) and position detection signals from a plurality of position detection sensors (Hall sensors) that detect a position of the movable section (movable section that holds the imaging element 210) with respect to the fixing section of the shake correction device 100, and controls the magnitude and the direction of the current flowing through each coil of the drive mechanism (voice coil motor in the present example) of the shake correction device 100 based on the shake detection signals and the position detection signals, to move the imaging element 210 to offset the shake.

The processor 240 is configured by a central processing unit (CPU) or the like, and performs overall control of each unit of the camera body 200 and various types of processing in accordance with a user operation using the operation unit 280.

The operation unit 280 includes the shutter release button 22, the shutter speed dial 23, the exposure correction dial 24, and the power lever 25 that are shown in FIG. 1, and the MENU/OK key, the cross key, and the play button that are not shown.

The memory 260 includes a flash memory, a read-only memory (ROM), a random-access memory (RAM), and the like. Further, the memory 260 includes a memory card that is attachable to and detachable from the camera body 200. The flash memory and the ROM are non-volatile memories that store firmware and other programs, and the flash memory stores captured images (still image or video), and the like.

The RAM functions as a work area for processing via the processor 240, and temporarily stores firmware and other programs stored in the non-volatile memory. It should be noted that a part (RAM) of the memory 260 may be built in the processor 240.

An imaging element drive unit (not shown) of the imaging element 210 performs control of reading out the image signal from the imaging element 210 in accordance with a command of the processor 240. In addition, the imaging element drive unit has an electronic shutter function of discharging (resetting) the accumulated charge in each pixel of the imaging element 210 by an electronic shutter control signal from the processor 240, to start the exposure.

The AFE 220 performs various types of analog signal processing on an analog image signal obtained by imaging the subject by the imaging element 210, and converts the image signal after the analog processing into a digital image signal. The analog processing in the AFE 220 includes, for example, color separation processing, and automatic gain control (AGC). The AGC functions as a sensitivity adjustment unit that adjusts a sensitivity (international-organization-for-standardization (ISO) sensitivity) during the imaging, and adjusts a gain of an amplifier that amplifies the input image signal so that a signal level of the image signal is within an appropriate range.

Image data (mosaic image data) for each pixel of RGB output through the imaging element 210 and the AFE 220 during the capturing of the still image or the video is input to the memory 260 and is temporarily stored therein. It should be noted that, in a case in which the imaging element 210 is a CMOS type image sensor, the AFE 220 is often built in the imaging element 210.

The processor 240 functions as a digital signal processing unit that performs various types of digital signal processing on the image data temporarily stored in the memory 260. That is, the processor 240 performs digital signal processing on the image data input via the AFE 220, such as offset processing, gain control processing including a sensitivity correction, gamma correction processing, demosaicing processing (also referred to as demosaicing processing or synchronization processing), and RGB/YCrCb conversion processing, and stores the image data after the digital signal processing in the memory 260 again. It should be noted that the demosaicing processing is processing of, for example, calculating color information of all the RGB for each pixel from a mosaic image consisting of RGB in a case of the imaging element 210 consisting of the color filters of RGB three colors, and generates demosaiced image data of RGB three planes from mosaic data (dot-sequential RGB data).

The RGB/YCrCb conversion processing is processing of converting the synchronized RGB data into brightness data (Y) and color difference data (Cb and Cr).

Further, the processor 240 performs compression processing on the uncompressed brightness data Y and color difference data Cb and Cr temporarily stored in the RAM of the memory 260 in a case in which the still image or the video is recorded. The still image is compressed in, for example, a joint photographic coding experts group (JPEG) format, and the video is compressed in, for example, an H.264 format. The compressed image data is recorded in the flash memory of the memory 260. The processor 240 reads out the compressed image data from the flash memory of the memory 260 in the playback mode, performs decompression processing on the read-out image data to generate uncompressed image data, and displays the uncompressed image data on the LCD 290 or the like via the display driver 250.

In a case in which the live view image is displayed on the LCD 290, the processor 240 outputs the digital image signal that is captured at a predetermined frame rate (for example, 30 fps or 60 fps) and is subjected to the digital processing, to the display driver 250. The display driver 250 converts the time-series digital image signals to be input into a signal format for display, and sequentially outputs the converted signals to the LCD 290. Accordingly, a captured image is displayed on the LCD 290 in real time.

The shutter release button 22 is an imaging instruction unit for inputting an instruction to capture the still image or the video, and is configured by a two-stage stroke type switch consisting of so-called “half push” (S1 push) and “full push” (S2 push).

An S1_ON signal is output by the “half push” of the shutter release button 22, and an S2_ON signal is output by the “full push” of further pushing the shutter release button 22 from the “half push”. In a case of a still image capturing mode, the processor 240 executes imaging preparation processing such as AF control (automatic focus adjustment) and AE control (automatic exposure control) in a case in which the S1_ON signal is output, and executes capturing processing and recording processing of the still image in a case in which the S2 ON signal is output.

In a case in which the AF control is performed, the processor 240 calculates a numerical value required for the AF control based on the digital image signal. In a case of a so-called contrast AF, for example, an integrated value (focus evaluation value) of a high-frequency component of a G signal in a predetermined AF area is calculated. The processor 240 moves the focus lens included in a lens group of the interchangeable lens 12 to a position at which the focus evaluation value is maximized (that is, a position at which the contrast is maximized) during the AF control. It should be noted that the AF is not limited to the contrast AF, and, for example, the AF may be performed by detecting a defocus amount based on pixel data of a phase difference detection pixel provided in the image sensor and moving the focus lens such that the defocus amount becomes zero.

In a case in which the AE control is performed, the processor 240 detects the brightness (subject brightness) of the subject and calculates a numerical value (exposure value (EV value)) required for the AE control corresponding to the subject brightness. The processor 240 can determine the F number, the shutter speed, and the ISO sensitivity from a predetermined program diagram based on the calculated EV value, and perform the AE control.

It goes without saying that the AF control and the AE control are automatically performed in a case in which an auto mode is set by the operation unit 280, and the AF control and the AE control are not performed in a case in which a manual mode is set.

In a case of a video capturing mode, in a case in which the S2_ON signal is output by the full push of the shutter release button 22, the camera body 200 is switched to a video recording mode in which the recording of the video is started, and the image processing and the recording processing of the video are executed, and, in a case in which the S2_ON signal is output by the full push of the shutter release button 22 again, the camera body 200 is switched to a standby state, and the recording processing of the video is temporarily stopped.

### Shake Correction Device

Subsequently, the shake correction device 100 will be described.

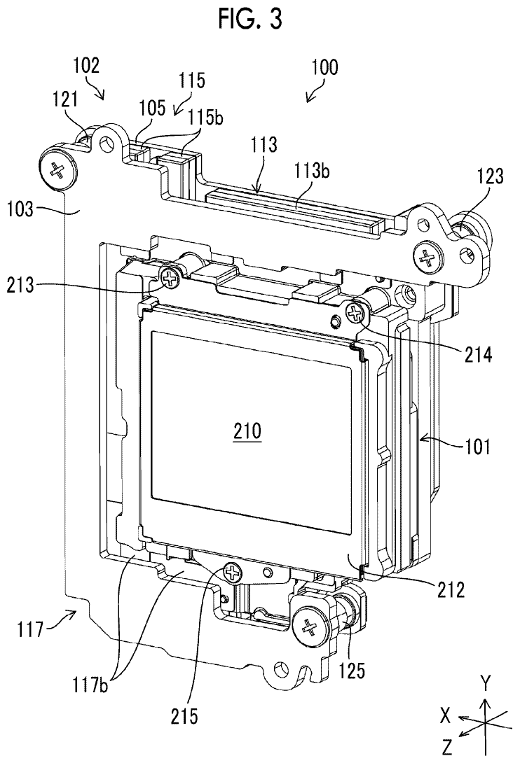

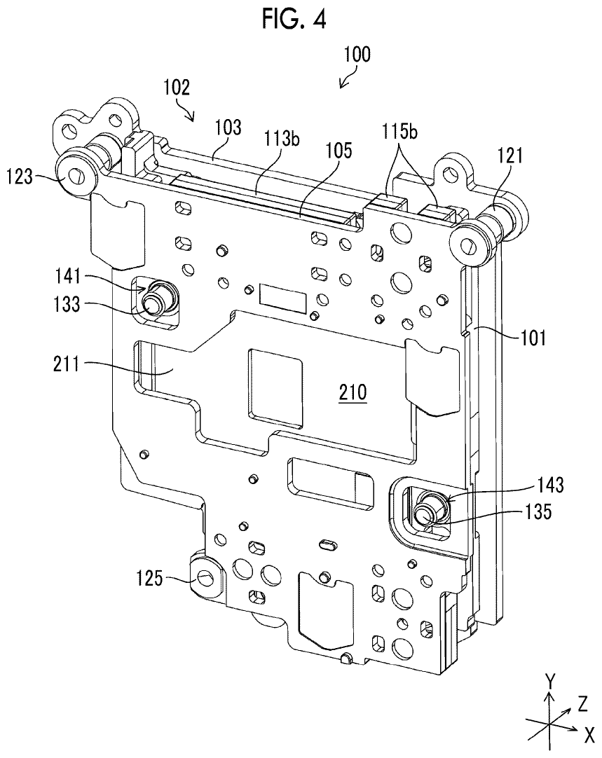

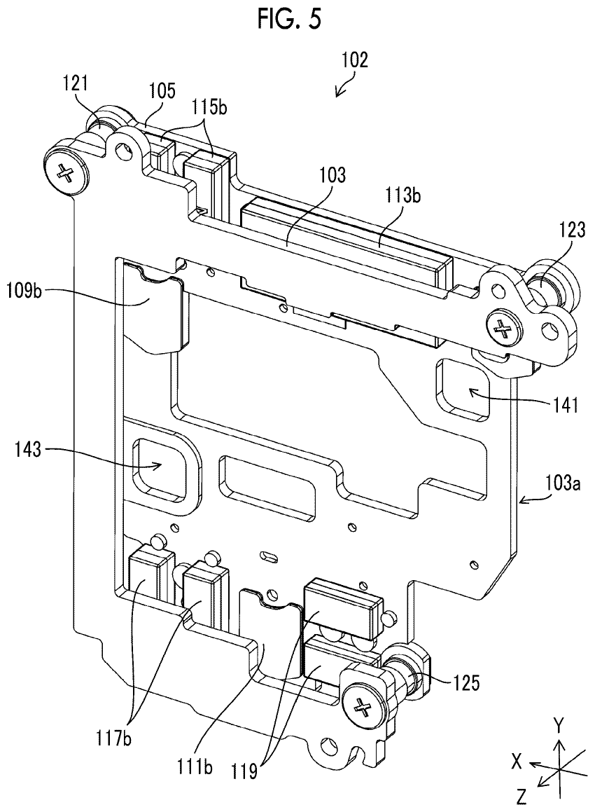

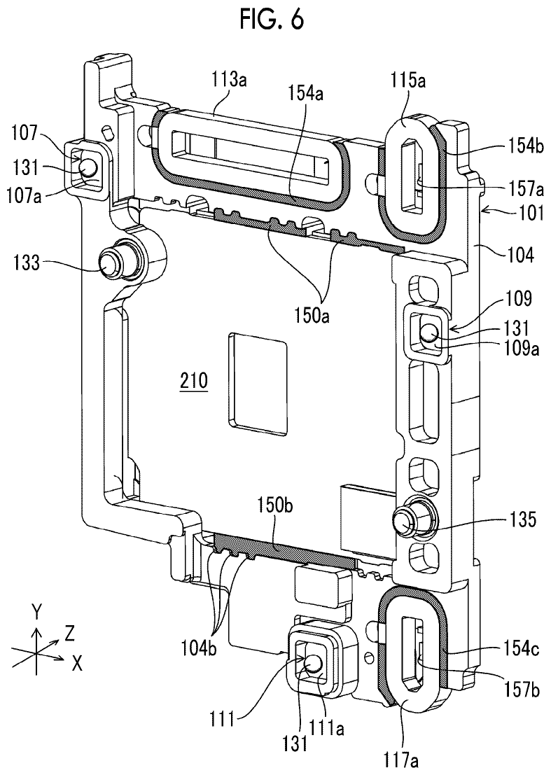

FIGS. 3, 4, 5, and 6 are views showing the shake correction device 100 mounted in the imaging device 10. FIG. 3 is a front perspective view of the shake correction device 100, FIG. 4 is a rear perspective view of the shake correction device 100, FIG. 5 is a front perspective view of a fixing section 102 of the shake correction device 100, and FIG. 6 is a rear perspective view of a movable section 101 of the shake correction device 100.

The shake correction device 100 mainly includes the movable section 101 on which the imaging element 210 is mounted, the fixing section 102 that is fixed to the camera body 200, and a drive mechanism (in the present example, three voice coil motors 113, 115, and 117) that moves (drives) the movable section 101 with respect to the fixing section 102.

A holding member 104 constituting the movable section 101 holds the imaging element 210 and holds the three coils 113a, 115a, and 117a.

The movable section 101 is in contact with the fixing section 102 via three balls 131. The movable section 101 is biased with respect to the fixing section 102 by an attractive force of a magnet (not shown) or an elastic force of a spring, and the three balls 131 are interposed between the movable section 101 and the fixing section 102.

The movable section 101 can be moved (translated and rotated) in a plane (X-Y plane in the drawing) orthogonal to the optical axis (Z-axis). That is, the movable section 101 supports the holding member 104 in a movable manner in a plane parallel to an imaging surface of the imaging element 210 with respect to the fixing section 102.

The three voice coil motors 113, 115, and 117 are composed of three coils 113a, 115a, and 117a (see FIG. 6), magnets 113b, 115b, and 117b (see FIG. 5), and a first yoke 103 and a second yoke 105 that are common to the three voice coil motors 113, 115, and 117.

A portion, in which the magnets 113b, 115b, and 117b of the second yoke 105 constituting the fixing section 102 are disposed, functions as the second yoke 105. The first yoke 103 is disposed to be spaced apart from the second yoke 105 via three shafts that are a shaft 121, a shaft 123, and a shaft 125.

In each of the magnets 113b, 115b, and 117b, a pair of magnets having opposite directions of magnetic poles are disposed side by side. Three magnetic circuits corresponding to the three voice coil motors 113, 115, and 117 are configured by the each pair of magnets 113b, 115b, and 117b, the first yoke 103, and the second yoke 105.

Meanwhile, the holding member 104 constituting the movable section 101 holds the imaging element 210 and holds the three coils 113a, 115a, and 117a. It should be noted that the structure of the holding member 104 and the details of a method of fixing the imaging element 210 and the coils 113a, 115a, and 117a to the holding member 104 will be described later.

In a case in which the movable section 101 is disposed in a movable manner with respect to the fixing section 102, the coils 113a, 115a, and 117a are disposed to cross the three magnetic circuits, respectively.

Therefore, the voice coil motor 113 moves the movable section 101 in the up-down direction (Y direction) in accordance with the direction of the current flowing through the coil 113a and the magnitude of the current, and the voice coil motors 115 and 117 move the movable section 101 in the left-right direction (X direction) in accordance with the direction of the current flowing through the coils 115a and 117a and the magnitude of the current. In addition, the movable section 101 can be rotationally moved in the X-Y plane by making the direction and/or magnitude of the current flowing through the coil 115a of the voice coil motor 115 and the coil 117a of the voice coil motor 117 different.

In addition, three Hall elements corresponding to three Hall sensors are disposed in the movable section 101. Two Hall elements 157a and 157b among the three Hall elements are disposed at the center parts of the coils 115a and 117a. The Hall elements 157a and 157b and the two magnetic circuits corresponding to the voice coil motors 115 and 117 constitute two Hall sensors that detect the position of the movable section 101 in the X direction, respectively.

Meanwhile, a pair of magnets 119 constituting the magnetic circuit of one remaining Hall sensor among the three Hall sensors is disposed on the second yoke 105 of the fixing section 102 (FIG. 5). The Hall element (not shown) corresponding to the remaining one Hall sensor among the three Hall sensors is disposed at a position on the movable section 101 facing the pair of magnets 119, and the Hall sensor detects the position of the movable section 101 in the Y direction.

Based on the positions detected by the three Hall sensors, the position and the rotation angle of the movable section 101 on the X-Y plane can be detected.

Three ball accommodation portions 107, 109, and 111 are formed in the holding member 104 of the movable section 101, and the ball 131 is accommodated in each of the ball accommodation portions 107, 109, and 111 (FIG. 6). It should be noted that metal plates 107a, 109a, or 111a serving as ball receiving surfaces are disposed on bottom surfaces of the ball accommodation portions 107, 109, and 111.

The ball 131 accommodated in each of the ball accommodation portions 107, 109, and 111 can roll in the ball accommodation portions 107, 109, and 111. Therefore, the movable section 101 can move freely on a plane orthogonal to the optical axis.

In addition, two restricting members (movable end restricting shafts) 133 and 135 are implanted at substantially diagonal positions in the holding member 104 (FIG. 6), and the restricting members 133 and 135 are loosely inserted into two restricting opening portions 141 and 143 formed in the second yoke 105 of the fixing section 102. Accordingly, in the movable section 101 (holding member 104), a movable range of the movable section 101 is mechanically restricted by the restricting members 133 and 135 abutting on the restricting opening portions 141 and 143.

### Holding Member

Subsequently, the holding member constituting the movable section will be described.

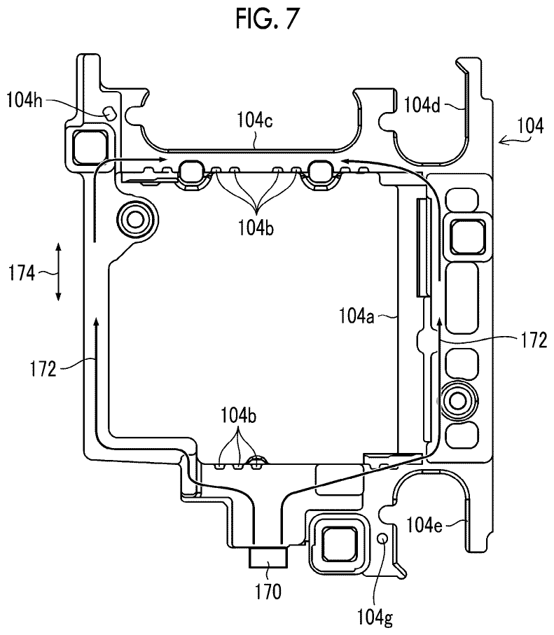

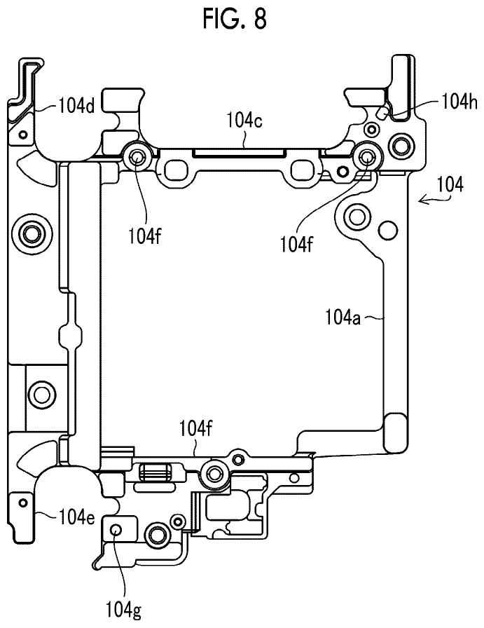

FIG. 7 is a rear view of the holding member constituting the movable section, and FIG. 8 is a front view of the holding member constituting the movable section.

The holding member 104 constituting the movable section 101 is a resin member molded of a resin in order to reduce the weight and the cost of the movable section 101. The holding member 104 includes a first opening portion 104a in which the imaging element 210 is disposed, includes, on an outer side of the first opening portion 104a, second opening portions 104c, 104d, and 104e in which the coils 113a, 115a, and 117a are disposed, and is molded in a frame shape.

It is preferable that the holding member 104 that holds the imaging element 210 is a high thermal conductivity resin having a high thermal conductivity. This is to suppress a temperature rise of the imaging element 210.

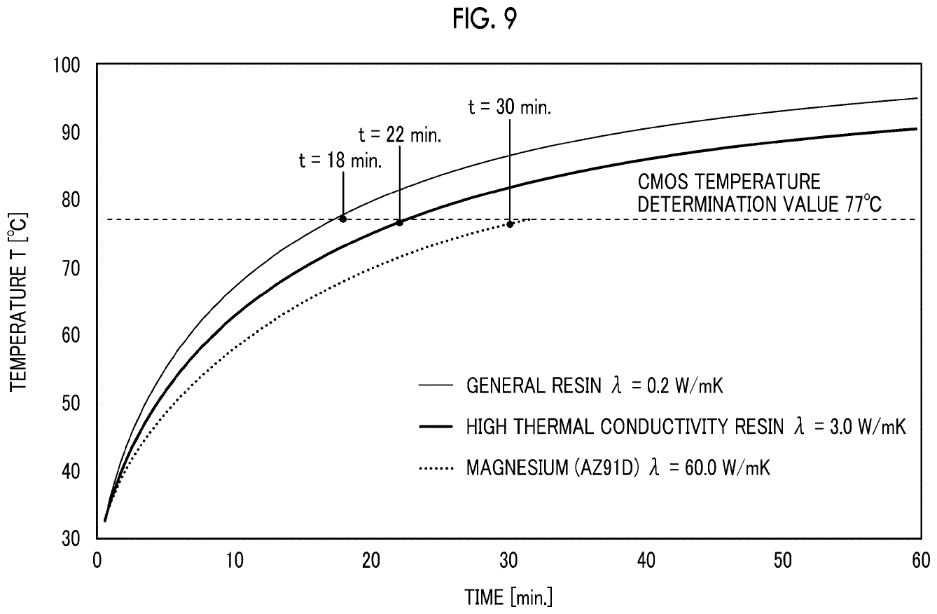

FIG. 9 is a graph showing an example of the temperature rise of a raw material of the holding member and the imaging element (CMOS) with respect to a usage time.

A temperature determination value of the imaging element is set to 77° C., and a time to reach 77° C. is measured.

In a case of a holding member in which a general resin having a thermal conductivity A of 0.2 (W/m/K) is used as the raw material, the temperature determination value reaches 77° C. after 18 minutes from the start of use.

In addition, in a case of a holding member of a magnesium alloy die casting (AZ91D) having a thermal conductivity λ of 60 (W/m/K), the temperature determination value reaches 77° C. after 30 minutes from the start of use.

Meanwhile, in a case of a holding member in which a high thermal conductivity resin having a thermal conductivity λ of 3 (W/m/K) is used as the raw material, the temperature determination value reaches 77° C. after 22 minutes from the start of use.

Therefore, as the resin used for molding the holding member 104, the high thermal conductivity resin having the thermal conductivity of 2 (W/m/K) or more is used, and the high thermal conductivity resin having the thermal conductivity of 3 (W/m/K) or more is preferably used.

Further, a resin containing carbon fibers can be used as the high thermal conductivity resin.

In FIG. 7, a reference numeral 170 indicates a gate position into which the resin flows in a case in which the holding member 104 is injection-molded. The resin that has flowed in from the gate position 170 is divided into left-right parts on the upper part of FIG. 7 and flows along arrows 172 and 172.

The carbon fibers contained in the resin are aligned in a direction (a direction indicated by an arrow 174) parallel to a flow direction of the resin, and the thermal conductivity is highest in a direction of the carbon fibers (that is, a direction of the arrow 174 along the frame shape). Therefore, in a case of the holding member 104 in which the high thermal conductivity resin containing the carbon fibers is used as the raw material, it is preferable that the direction of the carbon fibers contained in the holding member 104 is aligned in a direction along the frame shape of the holding member 104. Accordingly, it is possible to transfer the heat generated in the imaging element 210 to the holding member 104 molded of the high thermal conductivity resin and to efficiently diffuse the heat along the frame shape of the holding member 104.

It should be noted that the resin containing a high thermal conductive filler is not limited to the resin containing the carbon fibers, and may be a resin containing metal-based or metal oxide-based fibrous fillers.

In addition, it is preferable that the holding member 104 that holds the coils 113a, 115a, and 117a is molded of a conductive resin. In a case in which the movable section 101 is driven, a large current flows through the coils 113a, 115a, and 117a, and thus electromagnetic waves are generated in the vicinity of the coils 113a, 115a, and 117a, and the coils 113a, 115a, and 117a become noise sources for the imaging element 210.

In a case in which the coils 113a, 115a, and 117a are disposed in the second opening portions 104c, 104d, and 104e of the holding member 104 consisting of the conductive resin, an outer periphery (particularly, the imaging element 210 side) of the coils 113a, 115a, and 117a can be surrounded by the conductive resin. Therefore, an effect of reducing the influence of noise on the imaging element 210 can be obtained.

It should be noted that, since the high thermal conductivity resin containing the carbon fibers is also the conductive resin, the high thermal conductivity resin is suitable as the raw material of the holding member 104.

### Method of Fixing Imaging Element

Subsequently, the method of fixing the imaging element 210 to the holding member 104 will be described.

As shown in FIGS. 7 and 8, two positioning holes 104g and 104h are formed in the holding member 104. It should be noted that the positioning hole 104g is circular, and the positioning hole 104h is an elongated hole.

First, by inserting the two positioning holes 104g and 104h of the holding member 104 into two positioning pins of a jig (not shown), the holding member 104 is positioned on the jig.

Subsequently, the imaging element 210 is held, and a device that can adjust a three-dimensional position and posture of the imaging element 210 is used to adjust the position and the posture of the imaging element 210 such that the imaging element 210 has reference position and posture designated in advance, with respect to the holding member 104 positioned on the jig

In a state in which the imaging element 210 is positioned with respect to the holding member 104 as described above, a gap is present between the holding member 104 and the imaging element 210.

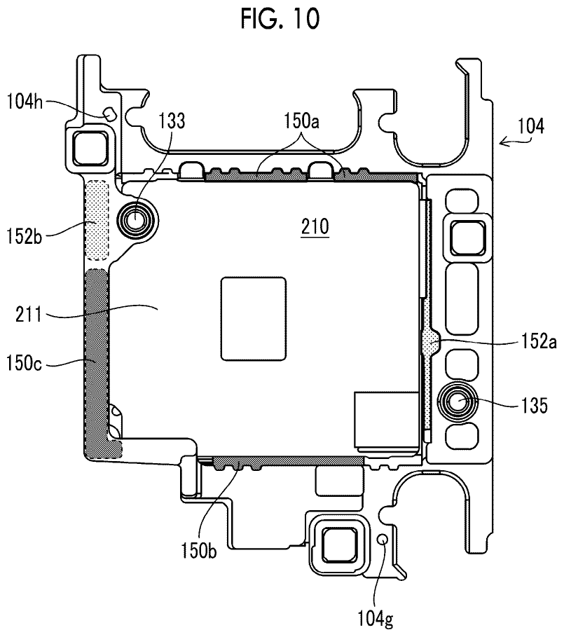

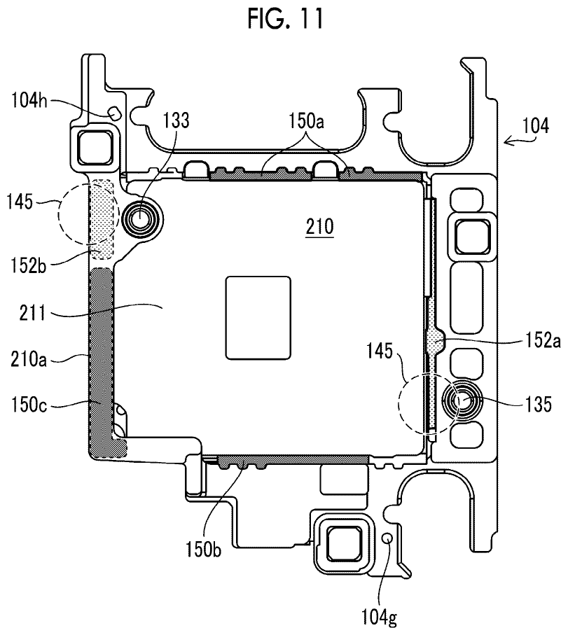

FIGS. 10 and 11 are rear views of the holding member to which the imaging element is adhesively fixed.

The imaging element 210 is fixed to the holding member 104 by an adhesive (first adhesives 150a, 150b, and 150c and second adhesives 152a and 152b), but a gap is present between the holding member 104 and the imaging element 210 before the application of (coating or filling with) the adhesive is performed.

A frame line 210a shown in FIG. 11 indicates four sides of the outer shape of the imaging element 210. In FIG. 11, a gap is present between side surfaces of the imaging element 210 corresponding to three sides of an upper side, a lower side, and a right side of an outer shape of the imaging element 210 and an inner peripheral surface of the first opening portion 104a of the holding member 104 in which the imaging element 210 is disposed, and a gap is present between a left frame of the holding member 104 and a substrate 211 of the imaging element 210 facing the left frame.

Then, after the imaging element 210 is positioned with respect to the holding member 104, the gap is filled with the first adhesives 150a, 150b, and 150c for fixing and the second adhesives 152a and 152b and solidified, to fix the imaging element 210 with respect to the holding member 104.

It should be noted that the first adhesive 150c and the second adhesive 152b may be applied to the left frame of the holding member 104 (back side of the left frame in FIG. 10) before the imaging element 210 is positioned, and, in a case in which the imaging element 210 is positioned, the gap between the left frame and the substrate 211 of the imaging element 210 facing the left frame may be filled with the first adhesive 150c and the second adhesive 152b.

The first adhesives 150a, 150b, and 150c among the first adhesives 150a, 150b, and 150c for fixing and the second adhesives 152a and 152b have a higher hardness than the second adhesives 152a and 152b. On the contrary, the second adhesives 152a and 152b having a lower hardness than the first adhesives 150a, 150b, and 150c are applied.

The first adhesives 150a, 150b, and 150c for fixing having at least a high hardness refer to those used for determining a relative position between the holding member 104 and the imaging element 210, and do not include an elastic adhesive for the purpose of improving a thermal conductivity.

In the present example, ultraviolet curable adhesives are used as the first adhesives 150a, 150b, and 150c. Therefore, the solidification is performed in a short time by performing the irradiation with ultraviolet rays after the filling with the first adhesives 150a, 150b, and 150c, and the relative position between the holding member 104 and the imaging element 210 is not changed by solidifying the first adhesives 150a, 150b, and 150c.

In addition, it is preferable that the first adhesives 150a, 150b, and 150c are not applied to the gap close to the restricting members 133 and 135, and are applied between the imaging element 210 and the holding member 104 spaced apart from the restricting members 133 and 135 by a first distance or more. For example, the first adhesive is not applied to a gap in a circle 145 close to the restricting members 133 and 135 shown in FIG. 11.

The first adhesives 150a and 150b of the present example fill the gaps between the side surfaces of the imaging element 210 corresponding to the upper side and the lower side of the outer shape of the imaging element 210 and the holding member 104, and are sufficiently spaced apart from the restricting members 133 and 135. In addition, the first adhesive 150c is also sufficiently spaced apart from the restricting member 133.

The reason why the first adhesives 150a, 150b, and 150c are applied between the imaging element 210 and the holding member 104 spaced apart from the restricting members 133 and 135 by the first distance or more is as follows.

Since the movable range of the movable section 101 is mechanically restricted by the restricting members 133 and 135 and the restricting opening portions 141 and 143, the restricting members 133 and 135 collide with the restricting opening portions 141 and 143 in a case in which an impact is applied to the imaging device 10 due to falling or the like, and a force of deforming the holding member 104 is applied to the vicinity of the restricting members 133 and 135.

In a case in which the holding member 104 is molded of a metal material having a high strength, the deformation can be reduced, but, in a case in which the holding member 104 is molded of the resin, a large displacement occurs instantaneously. This instantaneous deformation serves as a force of peeling the adhesive, and, in a case in which this force exceeds a holding force of the adhesive, the peeling occurs at an interface.

In a case in which the peeling occurs at the interface of the adhesive, the peeling spreads in a direction away from the holding member 104, and the relative position between the imaging element 210 and the holding member 104 is largely deviated.

Meanwhile, at a portion other than the vicinity of the restricting members 133 and 135 (at a distance of the first distance or more), the influence of the impact is small, and the adhesive is not peeled, so that the restricting members 133 and 135 can be firmly fixed.

In the present example, the first adhesives 150a, 150b, and 150c and the second adhesives 152a and 152b are applied, and the second adhesives 152a and 152b are applied to a portion different from the portions to which the first adhesives 150a, 150b, and 150c are applied, and are also applied to the gap in the circle 145 close to the restricting members 133 and 135 as shown in FIG. 11. It should be noted that the portion to which the second adhesives 152a and 152b are applied includes a portion excluding a shape that increases an adhesive area of the first adhesives 150a and 150b.

In a case in which the restricting members 133 and 135 collide with the restricting opening portions 141 and 143 and the holding member 104 is slightly deformed, the second adhesives 152a and 152b are also slightly deformed. It is preferable that the second adhesives 152a and 152b have a hardness (elasticity) such that the peeling at the interface does not occur in such slight deformation. It should be noted that the second adhesives 152a and 152b do not always need to be applied.

Since an adhesive force is greater as the adhesive area with the component is larger, the holding member 104 has a shape that increases the adhesive area of the first adhesives 150a and 150b. The holding member 104 of the present example has a plurality of recess-protrusion shapes 104b as shown in FIGS. 6 and 7, and increases the adhesive area.

The holding member 104 is molded in the frame shape as described above, but the recess-protrusion shape 104b is formed on at least two sides of the frame shape. In the present example, on FIG. 7, the recess-protrusion shape 104b is formed on the upper and lower sides of the first opening portion 104a of the holding member 104 in which the imaging element 210 is disposed.

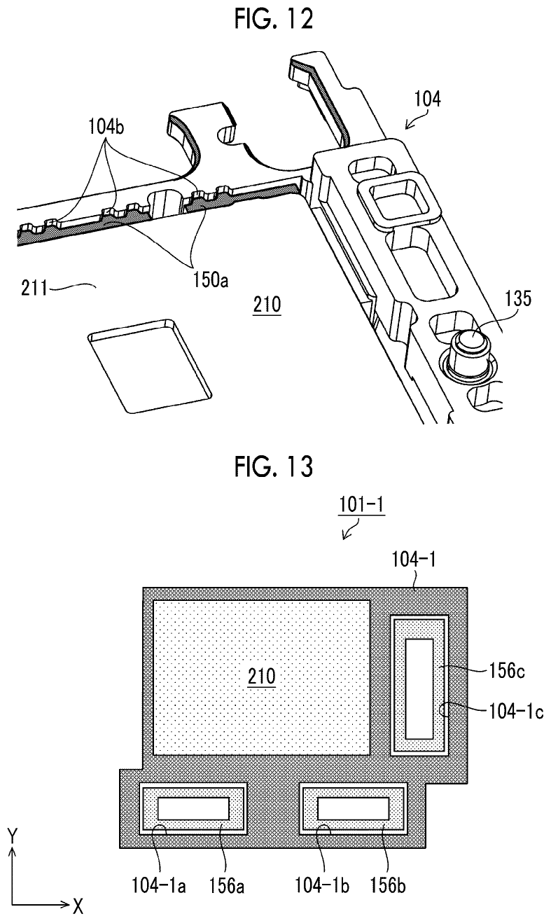

FIG. 12 is a perspective view showing a part of the holding member shown in FIG. 10.

As shown in FIGS. 6, 7, and 12, the plurality of recess-protrusion shapes 104b are formed on the inner peripheral surface of the first opening portion 104a of the holding member 104, in which the imaging element 210 is disposed.

In addition, a configuration may be adopted in which fine recess and protrusion such as a grain can be imparted to the portion of the holding member 104 in which the recess-protrusion shape 104b is formed instead of the recess-protrusion shape 104b or in addition to the recess-protrusion shape 104b, so that the adhesive force can be further reinforced.

### Method of Fixing Coil

Subsequently, the method of fixing the coils 113a, 115a, and 117a to the holding member 104 will be described.

Even in a case of fixing the coils 113a, 115a, and 117a to the holding member 104, the same method as the method of fixing the imaging element 210 to the holding member 104 can be performed.

That is, after the holding member 104 is positioned on the jig, the coil 113a is held, and a device that can adjust the three-dimensional position and posture of the coil 113a to adjust the position and the posture of the coil 113a such that the coil 113a has reference position and posture designated in advance, with respect to the holding member 104 positioned on the jig.

In a state in which the coil 113a is positioned with respect to the holding member 104, a gap is present between an inner peripheral surface of the second opening portion 104c of the holding member 104 and the coil 113a.

The gap between the inner peripheral surface of the second opening portion 104c of the holding member 104 and the coil 113a is filled with the first adhesive 154a as shown in FIG. 6 and solidified, to fix the coil 113a to the holding member 104.

Similarly, in other the coils 115a and 117a, the positions and postures of the coils 115a and 117a are adjusted such that the coils 115a and 117a have the reference positions and postures designed in advance, with respect to the holding member 104 positioned on the jig, and the gaps between the inner peripheral surfaces of the second opening portions 104d and 104e of the holding member 104 and the coils 113a and 117a are filled with the first adhesives 154b and 154c and solidified, to fix the coils 115a and 117a to the holding member 104.

The ultraviolet curable adhesives are used as the first adhesives 154a, 154b, and 154c. Therefore, the solidification can be performed in a short time by performing the irradiation with the ultraviolet rays after the filling with the first adhesives 154a, 154b, and 154c.

### Another Embodiment of Movable Section

FIG. 13 is a schematic view showing another embodiment of the movable section.

A holding member 104-1 of a movable section 101-1 shown in FIG. 13 has second opening portions 104-1a, 104-1b, and 104-1c to which three coils 156a, 156b, and 156c are fixed, respectively. The second opening portions 104-1a, 104-1b, and 104-1c each have a first opening shape in which an inner periphery of an opening portion is closed.

It should be noted that the holding member 104 shown in FIG. 7 includes the second opening portions 104c, 104d, and 104e to which the three coils 113a, 115a, and 117a are respectively fixed, but the second opening portions 104c, 104d, and 104e have a second opening shape in which a part of the inner periphery of each opening portion is open, and thus the holding member 104 is different in shape from the holding member 104-1.

The second opening portions 104-1a, 104-1b, and 104-1c of the holding member 104-1 have a first opening shape in which the inner periphery of the opening portion is closed, and thus the holding member 104-1 can surround the entire periphery of the coils 156a, 156b, and 156c. Accordingly, in a case in which the holding member 104-1 is molded of the conductive resin, the influence of the electromagnetic waves generated in the vicinity of the coils 156a, 156b, and 156c on the imaging element 210 can be reduced as compared with the holding member 104 shown in FIG. 7. Meanwhile, since the holding member 104 shown in FIG. 7 has a second opening shape in which a part of the inner periphery of the second opening portions 104c, 104d, and 104e is open (missing), the holding member 104 can be made smaller than the holding member 104-1.

### Shape of Screw Hole Formed in Holding Member

Subsequently, a shape of a screw hole formed in the holding member 104 will be described.

As shown in FIG. 8, three screw holes 104f are formed in the holding member 104.

Three male screws 213, 214, and 215 are fastened to the three screw holes 104f via a metal member 212 that covers an outer periphery of the imaging element 210 on the front surface side as shown in FIG. 3.

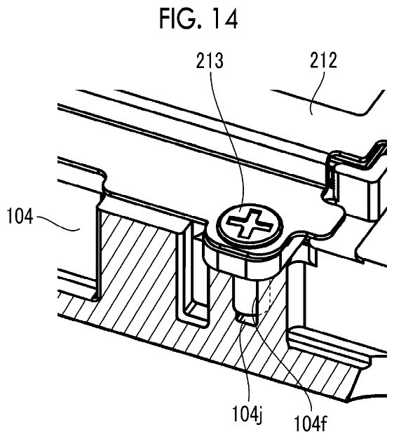

FIG. 14 is a main part cross-sectional view of the holding member including a cross section of the screw hole formed in the holding member.

In FIG. 14, the holding member 104 is molded of a resin material, and thus a screw is not formed in the screw hole 104f in advance. By screwing the male screw 213 into the screw hole 104f, a screw thread is formed (self-tapped).

In a case of the resin containing the carbon fibers, there is a problem in that an amount of dust generated by screwing in is larger than that of other resin materials.

The screw hole 104f formed in the holding member 104 of the present example is not a through hole, and is a non-through hole that is deeper than a length (screwing-in depth) of the male screw 213. Accordingly, dust generated by the screwing is accumulated in a space 104j between a distal end of the male screw 213 and a bottom portion of the screw hole 104f, and the dust is not diffused to the outside, so that it is possible to prevent the dust from adhering to the imaging element 210 and the interchangeable lens 12.

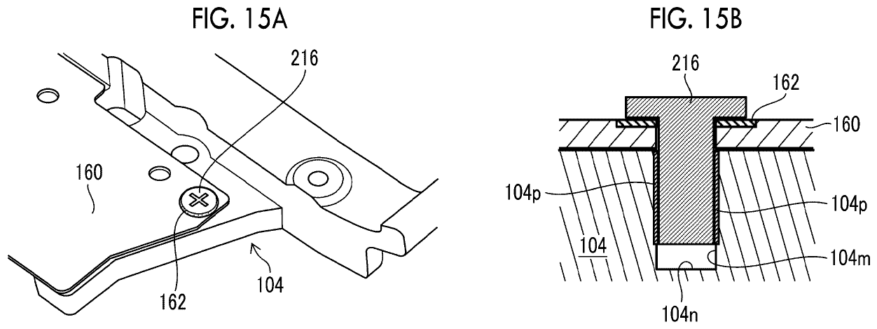

FIGS. 15A and 15B are diagrams showing a configuration in which flexible printed circuits (FPCs) connected to the rear surface side of the imaging element is fastened to the holding member. FIG. 15A is a main part perspective view showing a state in which the FPC 160 is fastened to the holding member 104 by a male screw 216, and FIG. 15B is a main part cross-sectional view of the holding member 104 including the cross sections of the male screw 216 and a screw hole 104m.

As shown in FIG. 15B, the screw hole 104m is a non-through hole that is deeper than a screwing-in depth of the male screw 216. As a result, similarly to a case shown in FIG. 14, the dust generated by the screwing is accumulated in a space 104n between the distal end of the male screw 216 and the bottom portion of the screw hole 104m, and is not diffused to the outside.

In addition, since the carbon fiber resin molded with a mold does not have conductivity on a molding surface, it is not possible to make the carbon fiber resin electrically conductive by attaching conductive cloth or the like.

However, as shown in FIG. 15B, in a case in which the male screw 216 is fastened while being self-tapped by the screwing into the screw hole 104m, an insulating layer on the surface of the screw hole 104m is destroyed, and thus the male screw 216 and the screw hole 104m are conductive to each other. In addition, a head portion of the male screw 216 has a structure that presses the conductive land 162 of the FPC 160, and the male screw 216 and the conductive land 162 can be conductive to each other.

That is, the conductive land 162 of the FPC 160 and the holding member 104 can be electrically connected to each other through the male screw 216.

### Others

The shake correction device according to the embodiment of the present invention is not limited to a case in which the shake correction device is applied to the mirrorless digital single-lens camera, and can be applied to various cameras such as a digital single-lens reflex camera, a lens-integrated compact camera, and a camera built in a smartphone.

In addition, the holding member is not limited to the shape shown in FIG. 7 or FIG. 13, various shapes can be used, and the configuration of the voice coil motor is also not limited to the present embodiment.

Further, the present invention is not limited to the embodiment described above, and it goes without saying that the modifications can be made without departing from the gist of the present invention.

### EXPLANATION OF REFERENCES

10: imaging device
12: interchangeable lens
22: shutter release button
23: shutter speed dial
24: exposure correction dial
25: power lever
100: shake correction device
101, 101-1: movable section
102: fixing section
103: first yoke
104, 104-1: holding member
104a: first opening portion
104b: recess-protrusion shape
104c, 104d, 104e, 104-1a, 104-1b, 104-1c: second opening portion
104f, 104m: screw hole
104g, 104h: positioning hole
104j, 104n: space
105: second yoke
107, 109, 111: ball accommodation portion
107a, 109a, 111a: metal plate
113, 115, 117: voice coil motor
113a, 115a, 117a, 156a, 156b, 156c: coil
113b, 115b, 117b, 119: magnet
121, 123, 125: shaft
131: ball
133, 135: restricting member
141, 143: restricting opening portion
145: circle
150a, 150b, 150c, 154a, 154b, 154c: first adhesive
152a, 152b: second adhesive
157a, 157b: Hall element
160: FPC
162: conductive land
170: gate position
172, 174: arrow
200: camera body
210: imaging element
210a: frame line
211: substrate
212: metal member
213, 214, 215, 216: male screw
230: shake control unit
240: processor
250: display driver
260: memory
262: body mount
270: shake detection sensor
280: operation unit
290: LCD

What is claimed is:

1. A shake correction device that drives an imaging element by using a drive mechanism to perform a shake correction, the shake correction device comprising:
a fixing section that includes a magnet and a yoke that constitute the drive mechanism; and
a movable section that includes a holding member that holds a coil constituting the drive mechanism and the imaging element, and that supports the holding member in a movable manner,
wherein the imaging element and the holding member adhere to each other with a first adhesive and a second adhesive different from the first adhesive, and
a second adhesive is applied to a portion different from a portion to which the first adhesive is applied.

2. The shake correction device according to claim 1,
wherein the drive mechanism is a voice coil motor.

3. The shake correction device according to claim 1,
wherein the movable section supports the holding member in a movable manner in a plane parallel to an imaging surface of the imaging element with respect to the fixing section.

4. The shake correction device according to claim 1,
wherein the holding member is a resin member molded of a high thermal conductivity resin.

5. The shake correction device according to claim 4,
wherein a thermal conductivity of the high thermal conductivity resin is 2 (W/m/K) or more.

6. The shake correction device according to claim 4,
wherein a thermal conductivity of the high thermal conductivity resin is preferably 3 (W/m/K) or more.

7. The shake correction device according to claim 4,
wherein the high thermal conductivity resin is a resin containing fibrous fillers.

8. The shake correction device according to claim 7,
wherein the holding member is molded in a frame shape, and
a direction of the fibrous fillers in the holding member is aligned in a direction along the frame shape.

9. The shake correction device according to claim 1,
wherein the holding member is a resin member molded of a conductive resin.

10. The shake correction device according to claim 4,
wherein the holding member is a resin member molded of a conductive resin.

11. The shake correction device according to claim 1,
wherein the holding member has a shape that increases an adhesive area of the first adhesive.

12. The shake correction device according to claim 11,
wherein the first adhesive is applied in the shape.

13. The shake correction device according to claim 11,
wherein the shape is a recess-protrusion shape.

14. The shake correction device according to claim 13,
wherein the holding member has a plurality of the recess-protrusion shapes.

15. The shake correction device according to claim 14,
wherein the holding member is molded in a frame shape and has the plurality of recess-protrusion shapes on at least two sides of the frame shape.

16. The shake correction device according to claim 1,
wherein the first adhesive is an ultraviolet curable adhesive.

17. The shake correction device according to claim 1,
wherein the second adhesive has a lower hardness than the first adhesive.

18. The shake correction device according to claim 17,
wherein the holding member includes a restricting member that restricts a movable range of the movable section by abutting on the fixing section, and
the first adhesive is applied between the imaging element and the holding member that are spaced apart from the restricting member by a first distance or more.

19. The shake correction device according to claim 18,
wherein the holding member has a shape that increases an adhesive area of the first adhesive, and
the shape that increases the adhesive area of the first adhesive is spaced apart from the restricting member by the first distance or more.

20. The shake correction device according to claim 18,
wherein the holding member has a shape that increases an adhesive area of the first adhesive, and
the different portion is a portion excluding the shape that increases the adhesive area of the first adhesive.

21. The shake correction device according to claim 4,
wherein the holding member is formed with a screw hole that is a non-through hole deeper than a length of a male screw.

22. The shake correction device according to claim 1,
wherein the holding member includes a first opening portion in which the imaging element is disposed and includes, on an outer side of the first opening portion, a second opening portion in which the coil is disposed, and
a space between the coil and an inner peripheral surface of the second opening portion is filled with the first adhesive.

23. The shake correction device according to claim 22,
wherein the second opening portion has a first opening shape in which a periphery of the second opening portion is closed or a second opening shape in which a part of the periphery of the second opening portion is open.
